(19) United States
(12) Patent Application Publication
(10) Pub. No.: US 2013/0219098 A1
(43) Pub. Date: Aug. 22, 2013

(54) Mobile Device Docking Station

(71) Applicant: RPT COMMUNICATIONS INC., (US)

(72) Inventors: Robert Paul TURNPENNY, Clarksburg (CA); Gary LEE, Kanata (CA); Sunny LEE, Ottawa (CA); Greg FILL, Kemptville (CA); Qingshu ZHANG, Ottawa (CA)

(73) Assignee: RPT COMMUNICATIONS INC., Mississauga (CA)

(21) Appl. No.: 13/838,555

(22) Filed: Mar. 15, 2013

Related U.S. Application Data
(63) Continuation-in-part of application No. PCT/CA2012/050474, filed on Jul. 11, 2012.
(60) Provisional application No. 61/506,236, filed on Jul. 11, 2011.

(51) Int. Cl. G06F 1/16

(52) U.S. Cl. CPC G06F 1/1632
USPC 710/303

(57) ABSTRACT

A docking station adapted to receive and communicate with one or more mobile device. An interchangeable docking module can be removably engaged on the docking station. The docking module is adapted to receive a mobile device. Once the mobile device is received (“docked”) in the docking module, the docking station may be operable to deliver an electric current to charge the mobile device. A communication link between the docking station and the mobile device may also be established. A user may configure various functions of the mobile device using the docking station.

### CROSS REFERENCE

This application is a continuation-in-part of PCT Application Serial No. PCT/CA2012/050474 filed Jul. 11, 2012, which claims priority to U.S. Patent Application Ser. No. 61/506,236, filed Jul. 11, 2011, all the contents of which are herein incorporated by reference.

### FIELD OF THE INVENTION

The present invention relates generally to a docking station for a mobile device.

### BACKGROUND

In recent years, mobile phones have become indispensable for many businesses around the world. Users are increasingly dispensing with traditional land-line based phones in favour of such mobile devices.

However, there are disadvantages to using a mobile phone rather than a land-line based phone as a primary method of telecommunication, particularly in an office environment. One such disadvantage is that some users find it uncomfortable to have a conversation for any extended period of time using a mobile phone. This can be attributed in part to the limited size and quality of built-in speakers and microphones in many mobile phones. While some mobile phones include a speakerphone to enable a hands-free experience, many users perceive the sound quality of such speakerphone to be poor. Such implementations are also not conducive to particular situations, such as a conference call where multiple callers may be present in the same room and are sharing one mobile phone. Similarly, ergonomic aspects of the design are often overlooked in favour of aesthetics and compactness. Mobile phones generally have a size and shape that, when the mobile phone is held by a user, causes strain to a user's hand.

Mobile phones also have a limited battery capacity. Users sometimes neglect to charge their mobile phone, and are forced to either reconfigure their mobile phone in order to conserve the remaining charge in their battery, or turn their mobile phone off during the day.

The proposed devices and methods obviate or mitigate one or more of the above disadvantages.

### SUMMARY

Example embodiments and example aspects of the embodiments are provided below.

In a general example embodiment, a docking station for a mobile device is provided. The docking station includes: an interface adapted to receive a docking module that is removably mountable to the interface, the docking module adapted to receive the mobile device; and a communication module operable to enable communication between the docking station and said mobile device.

In one aspect, the docking station further includes a processor, a memory device, and a speaker, wherein the processor is configured to obtain a dial tone from the memory device and output the dial tone over the speaker. In another aspect, the docking module is operable to deliver a charging current to the mobile device when the mobile device is placed in the docking module and the docking module is mounted to the interface. In another aspect, the charging current is delivered wirelessly to the mobile device. In another aspect, the wireless delivery is inductive charging. In another aspect, the communication module enables communication only upon the docking module delivering the charging current. In another aspect, the communication is provided by Bluetooth, IEEE 802.11, infrared or radio frequency. In another aspect, the interface is positioned on a user facing surface of the docking station. In another aspect, the docking station further includes a microphone and a speaker. In another aspect, the microphone and the speaker provide full-duplex speakerphone communications via the mobile device. In another aspect, the docking station further includes a digital signal processor to condition voice communications. In another aspect, the docking station further includes a power amplifier to increase signal output of the speaker. In another aspect, the docking station further includes a plurality of buttons to control the mobile device. In another aspect, one or more of the buttons control user-defined functions of the mobile device. In another aspect, the docking station includes a processor and a memory device, and the processor is configured to store user inputted numbers in the memory device and to send the stored numbers to the mobile device, when the mobile device is placed in the docking module and the docking module is mounted to the interface. In another aspect, the docking module comprises a pivot to enable the adjustment of a viewing angle of the mobile device. In another aspect, the docking station further includes a mounting support. In another aspect, the mounting support comprises a curved path to enable adjustment of the viewing angle of the docking station. In another aspect, the mounting support includes a swivel to enable swiveling of the docking station. In another aspect, the docking station further includes a plurality of buttons positioned below the interface, the plurality of buttons and the interface positioned on a user facing surface of the docking station. In another aspect, the communication module is further operable to enable transmission of data between the mobile device and another docking station when the mobile device is placed in the docking module and the docking module is mounted to the interface.

In another aspect, the docking station further includes a second interface adapted to receive a second docking module that is removably mountable to the second interface, the second docking module adapted to receive a second mobile device.

In another general example embodiment, a docking station for a mobile device is provided. The docking station includes: a docking module adapted to deliver a charge to said mobile device; and a communication module operable to enable communication between said docking station and said mobile device upon said delivering said charge.

In another general example embodiment, a kit of parts is provided that, when assembled, form a docking station with a docking module. The kit of parts include the docking module adapted to receive a mobile device, the docking module removably mountable to the docking station. The kit of parts also include the docking station, and the kit of parts includes an interface adapted to receive the docking module. The kit of parts also include a communication module operable to enable communication between the docking station and the mobile device.

In another general example embodiment, a docking module is provided, and the docking module is configured to receive a mobile device and is configured to be removably mounted to a docking station. The docking module includes: a space configured to receive the mobile device, the space defined at least by a front barrier configured to retain the mobile device and a lower surface configured to support the mobile device; at least one mounting element configured to interface with the docking station; a current transmission element configured to receive current from the docking station; and at least one charging module configured to transmit current received from the docking station to the mobile device.

This Summary is provided to introduce a selection of concepts in a simplified form, examples of which are described in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments of the invention will now be described by way of example only with reference to the appended drawings wherein:

FIG. 1 is a front view of a docking station with a mobile device docked in the docking station in an example embodiment;

FIG. 2 is a front perspective view of the docking station in FIG. 1 shown without a handset and a mobile device;

FIG. 3 is a front view of a docking station in another example embodiment;

FIG. 4 is a front view of an example embodiment of a docking station with a docking module removed;

FIG. 5 is a front perspective view of an example embodiment of a docking module shown in isolation;

FIG. 6 is a side view of the docking station on a mounting support in an example embodiment;

FIG. 7 is a rear view of the docking station on a mounting support in an example embodiment;

FIG. 8 is a rear view of the docking station shown in FIG. 7 without a mounting support;

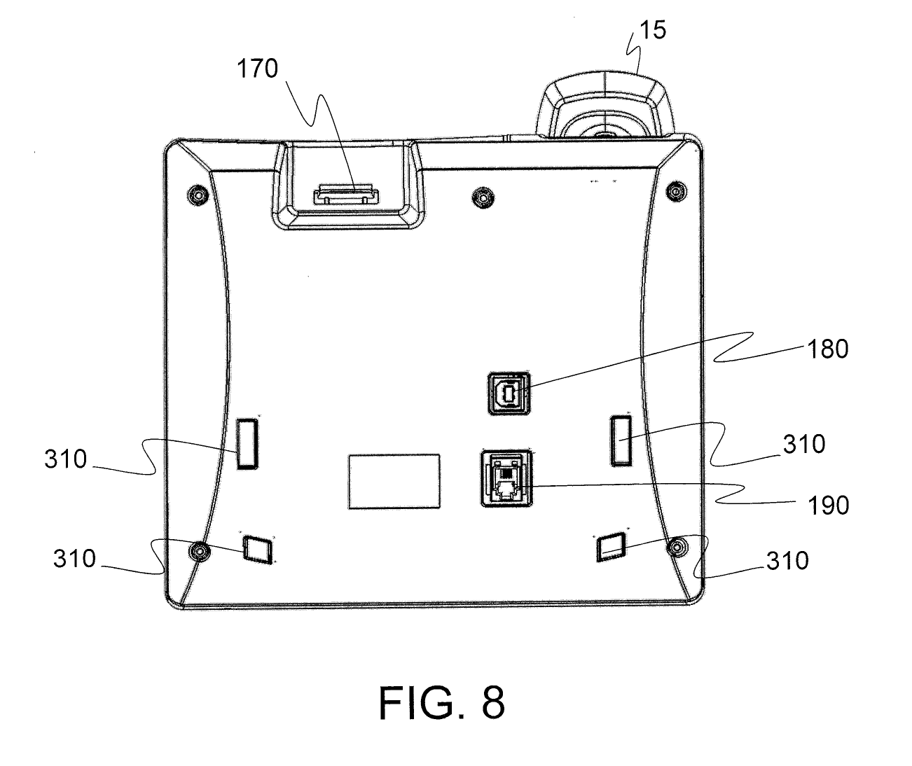

FIG. 9 is a block diagram of an example embodiment of a docking station;

FIG. 10 is a block diagram of an example embodiment of a mobile device;

FIG. 11 is a flowchart illustrating example processor executable instructions when docking a mobile device to the docking station;

FIG. 12 is a block diagram illustrating an example embodiment of a connection between the docking station and the mobile device;

FIG. 13 is a flowchart illustrating example processor executable instructions for connecting to an incoming or outgoing call on a mobile device when the mobile device is not docked to the docking station, and then activating a speaker and a microphone on the docking station when the mobile device is docked on the docking station;

FIG. 14 is a flowchart illustrating example processor executable instructions for connecting to an incoming or outgoing call on a mobile device when the mobile device is docked to the docking station, and then activating a speaker and a microphone on the mobile device when the mobile device is removed from the docking station;

FIG. 15 is a block diagram illustrating example components in the memory of a docking station;

FIG. 16 is a flowchart illustrating example processor executable instructions for using a docking station to make an outgoing call via a mobile device docked on the docking station;

FIG. 17 is a front view of an example embodiment of a docking station configured to dock two mobile devices;

FIG. 18 is a schematic diagram of an example embodiment of several docking stations in communication with each other over a network.

FIG. 19 is a flowchart illustrating example processor executable instructions for receiving an incoming call through a mobile device docked on a first docking station using a second docking station; and

FIG. 20 is a flowchart illustrating example processor executable instructions for making an outgoing call using a first docking station, a second docking station and a mobile, the mobile device docked on the first docking station and the audio input and output being provided by the second docking station.

### DETAILED DESCRIPTION

Example embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It will also be appreciated that any module, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

The proposed docking station is adapted to receive and communicate with one or more mobile devices. The docking station includes or is adapted to engage a docking module. The docking module is adapted to receive a mobile device. Once the mobile device is received (“docked”) in the docking module, the docking station may be operable to deliver to the mobile device an electric current to charge the mobile device. A communication link between the docking station and the mobile device may also be established. A user may apply various commands to the mobile device using the docking station.

The mobile device may, for example, be a cellular device, smartphone, personal digital assistant (PDA), tablet computer, or any other mobile device providing voice, video and/or data communication, whether by cellular, 2G, 3G, 4G, 5G, etc., WI-FI (IEEE 802.11), WiMax, VoIP or other protocol. The mobile device may further be operable to establish a communication connection with other devices. For example, the mobile device may comprise a short-range wireless communication module to enable it to establish short-range wireless communications with other devices. Examples of short-range wireless communications include, but are not limited to, Bluetooth™, WiFi (802.11), infrared (IR)), radio frequency (RF), and other communication protocols. In one example, the mobile device includes a Bluetooth module, and is operable to communicate with other devices over a short distance in accordance with the Bluetooth protocol.

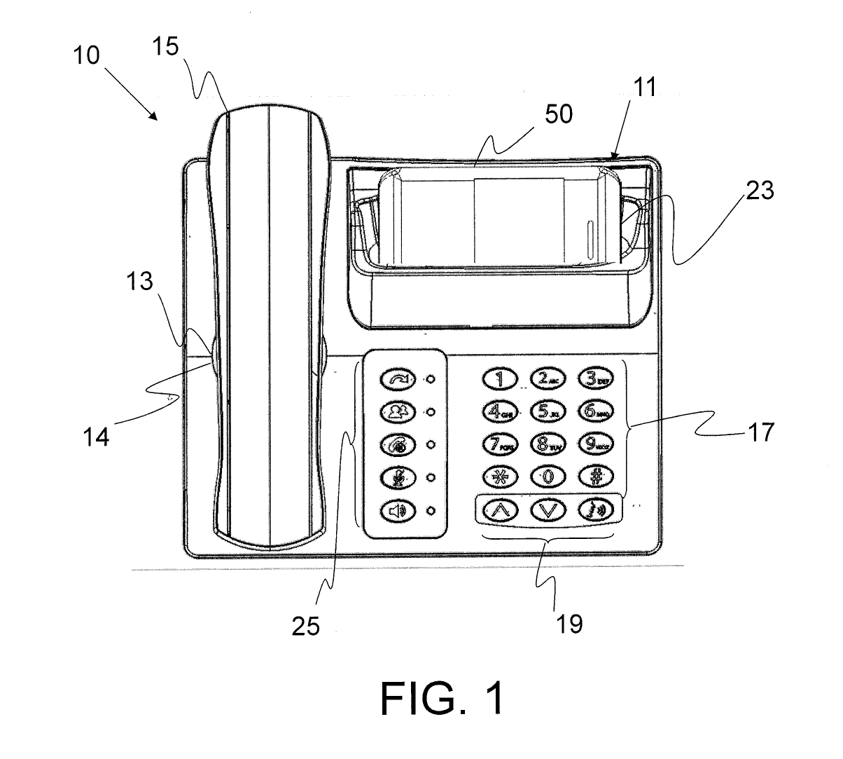

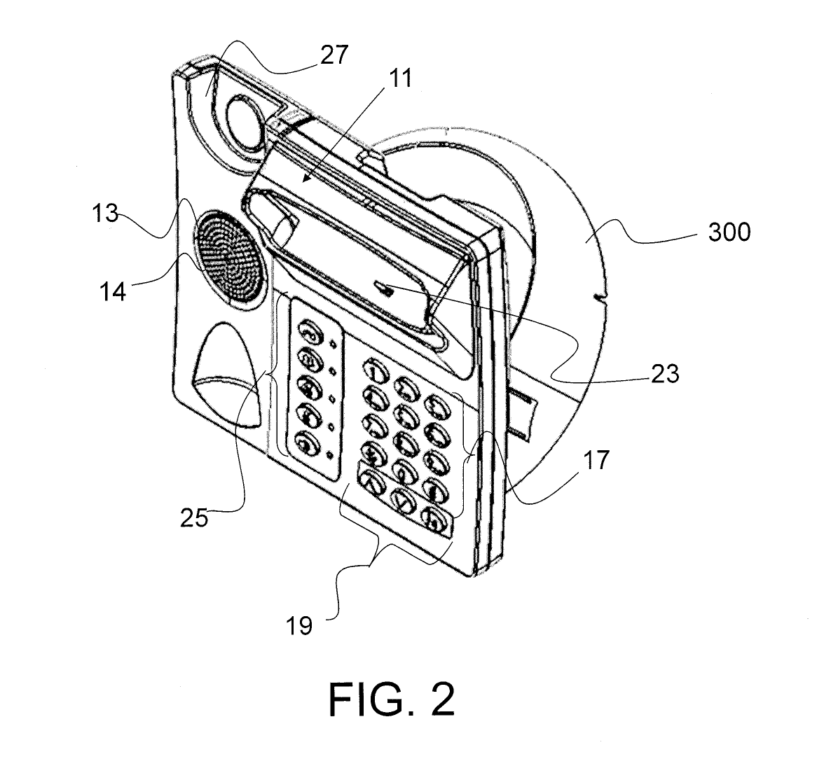

Referring now to FIG. 1 and FIG. 2, the docking station 10 comprises or is adapted to engage a docking module 11 that is adapted to receive a mobile device 50. Preferably, the docking module 11 is disposed on, or engageable on, a front surface (e.g., a user-facing surface) of the docking station 10.

Docking station 10 may further include a speakerphone, and the speakerphone includes an audio speaker 13, a microphone 14. The speakerphone can be used for hands-free communication. The docking station 10 further includes a handset 15, and the handset 15 further includes a microphone and/or audio speaker (not shown). The docking station further includes a plurality of buttons 17, 19, 25. The plurality of buttons may, for example, include a numeric dial pad 17, up/down volume control keys and speakerphone toggle key 19 and a set of configurable function keys 25. As can be appreciated, any of the plurality of buttons may be omitted or varied.

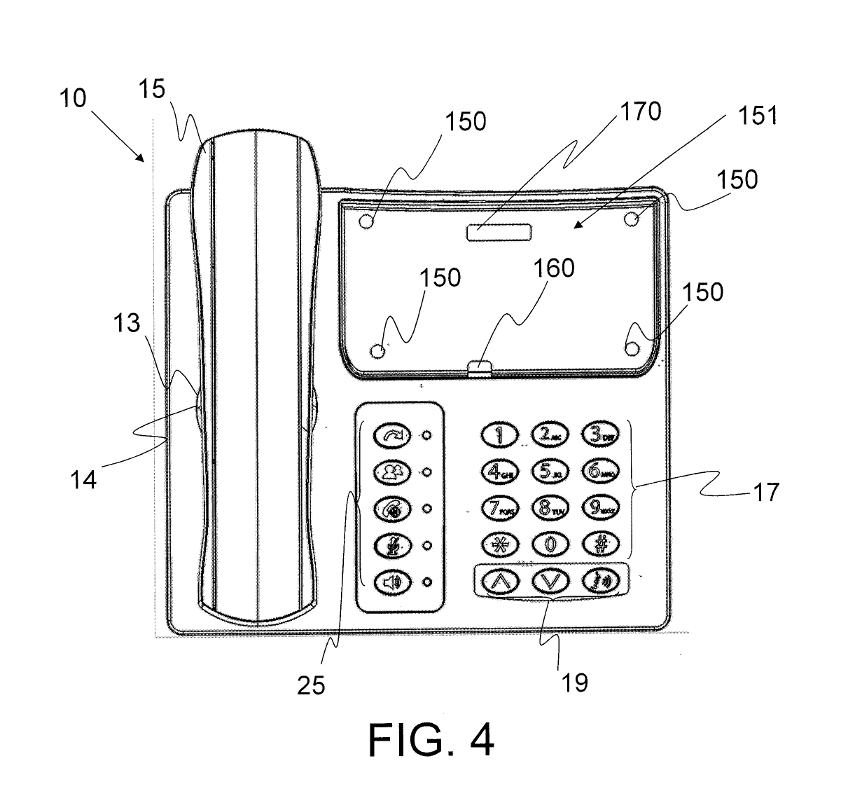

As best shown in FIG. 1, even when the mobile device 50 is docked in the docking module 11, the buttons 17, 19 and 25 remain unobstructed and are able to be used. In an example embodiment, the buttons 17, 19 and 25 are positioned below the position of the docking module 11. In another example embodiment, the buttons 17, 19 and 25 are positioned beside the position of the docking module 11. In another example embodiment, an interface (shown in FIG. 4) is provided to receive the docking module, and the buttons are positioned below the interface or beside the interface or both. Other positioning of the buttons can be used, if the buttons remain readily accessible to a user even when the mobile device 50 is docked.

Docking module 11 includes a charging module to transmit current that was received from the docking station to the mobile device. The charging module may be connected to a charging adapter 23. Preferably, the charging adapter 23 is of a size and shape enabling it to receive a corresponding mobile device by cradling the mobile device, for example. The docking module 11 may further include a connection status indicator (not shown). In other example embodiments, there are multiple charging modules. In an example embodiment, the multiple charging modules are used to charge different types of mobile devices, one at a time, within the same docking module. In another example embodiment, the multiple charging modules are used to charge multiple mobile devices at the same time within an enlarged docking module that is configured to hold multiple mobile devices at the same time. The one or more charging modules may include, for example, a wired port adapted to engage with a charging inlet of a mobile device and operable to deliver a charge to the battery of the mobile device. A charging adapter connected to the charging module may be raised from the body of the docking module 11 to allow a user to easily dock and undock the mobile device 50. In another example embodiment, the one or more charging modules include an inductive charging element that is operable to deliver a charge to the battery of the mobile device via an inductive charging element of the mobile device. It can be appreciated that currently known and future known devices and technologies for charging a mobile device can be used with the docking module 11 described herein.

In an example embodiment, the connection status indicator (e.g. a light source) is located on the front of the docking station 10, and may be positioned near the function keys 25.

In another example embodiment, the docking module 11 further includes a pivot that enables the user to adjust a viewing angle of the mobile device 50 to, for example, more easily view the display of the mobile device 50 while the device is docked. The pivot allows the docking module 11 to tilt to a desired angle. As will be appreciated, different variations of the docking module 11 can be used with the docking station 10. In particular, different variations of the docking module have different shapes and sizes to receive different types of mobile devices. Furthermore, docking station 10 may comprise an adjustable mounting support 300.

Audio speaker 13 and microphone 14 are operable to enable hands-free communication without the use of any speakers built-in to the mobile device 50 or the handset 15 on the docking station 10. Audio speaker 13 and microphone 14 can, for example, be activated manually by the user through pressing one of the function keys 25 at any point during a call, or by picking up the handset from its resting place on the docking station. In an example embodiment, the user may set the docking station 10 to always activate audio speaker 13 and microphone 14 for phone calls. In a preferred embodiment, audio speaker 13 and microphone 14 provide a full-duplex speakerphone capable of simultaneously transmitting and receiving audio signals. The speakerphone may be linked to a digital signal processing module to condition voice communications, including to reduce undesirable audio effects, such as echo and background noise, from being transmitted or received. The speaker may be power amplified to allow for increased signal output (e.g. increased volume output). The volume of audio speaker 13 and/or microphone 14 may be adjusted using the up and down volume control key 19. As will be appreciated, technical characteristics of audio speaker 13 and/or microphone 14 may be selected to provide appropriate volume and clarity.

Optionally, if the user wishes to dial a phone number using the dial pad 17, a dial tone can be output from the speakerphone and/or handset, mimicking a more traditional telephone. It is recognized, for example, that recent telephonic and communication devices provide a user experience that is not familiar because of different sounds or the lack of sounds being generated. This difference in user experience can cause confusion about the different stages of making a telephone call (e.g. lifting a receiver off the hook, dialing a number, waiting for the desired call recipient to answer, receiving an indicator that the recipient has “hung up”, etc.).

Handset 15 enables the user to preserve privacy during a call, as compared to a speakerphone which allows anyone in the vicinity to hear the telephone conversation. The handset 15 can be connected to the docking station 10 over a wireless connection or a wired connection. In an example embodiment, the handset 15 or docking station 10, or both, are adapted to automatically activate the handset 15 when the handset is removed from the docking station 10 by the user. For example, the rest 27 may have a size and shape generally corresponding to the size and shape of a portion of the handset, to retain the handset on a surface of the docking station 10. Either the rest, the handset, or both, may include a mechanical, electrical or electromechanical switch for detecting whether the handset is retained in the rest.

One or more of the function keys 25 may be configured to toggle or otherwise switch voice communication between the speakerphone 13 and the handset 15. Function keys 25 may also be configured for operating any other feature of the docking station, such as mute, for example. One or more of the function keys 25 may further be configured to initiate user-defined functions of the mobile device (such as transfer call, conference call, access contact list, navigate mobile device user interface, for example), as supported by the particular communication connection between the docking station and the mobile device. The function keys 25 may additionally be configured or reconfigured by a user based on the user's preference regarding which functions of the docking station and/or mobile device to assign to the function keys. Similar to the speakerphone 13, the volume of the handset speaker may be adjusted using the up and down volume control key 19.

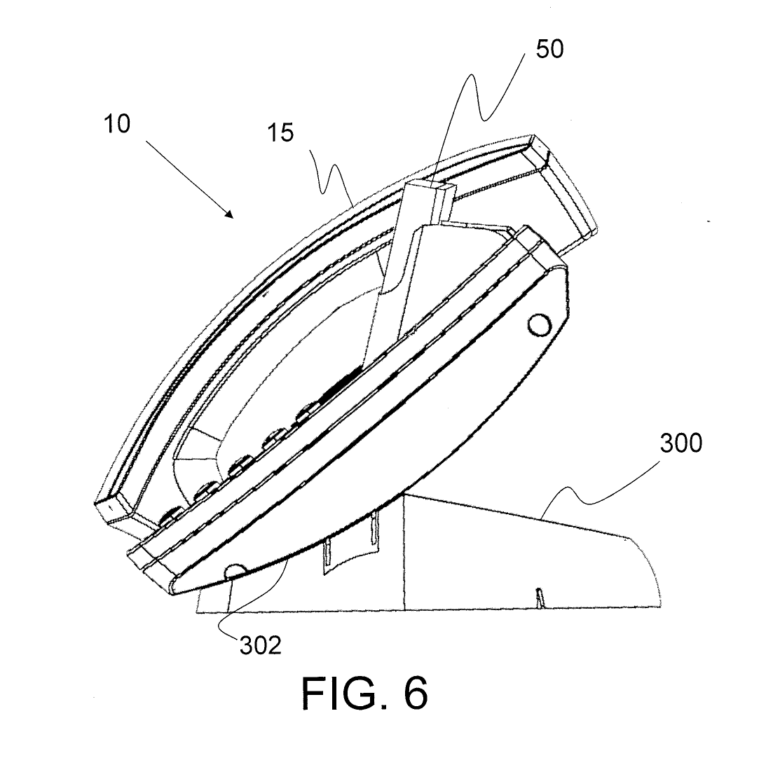

Mounting support 300 as shown in FIG. 2 is operable to enable a user to adjust the height and the angle of docking station 10. FIG. 6 shows another example embodiment of the mounting support 300 wherein the viewing angle of the docking station 10 is slideably adjusted along the curved path 302 of the mounting support 300.

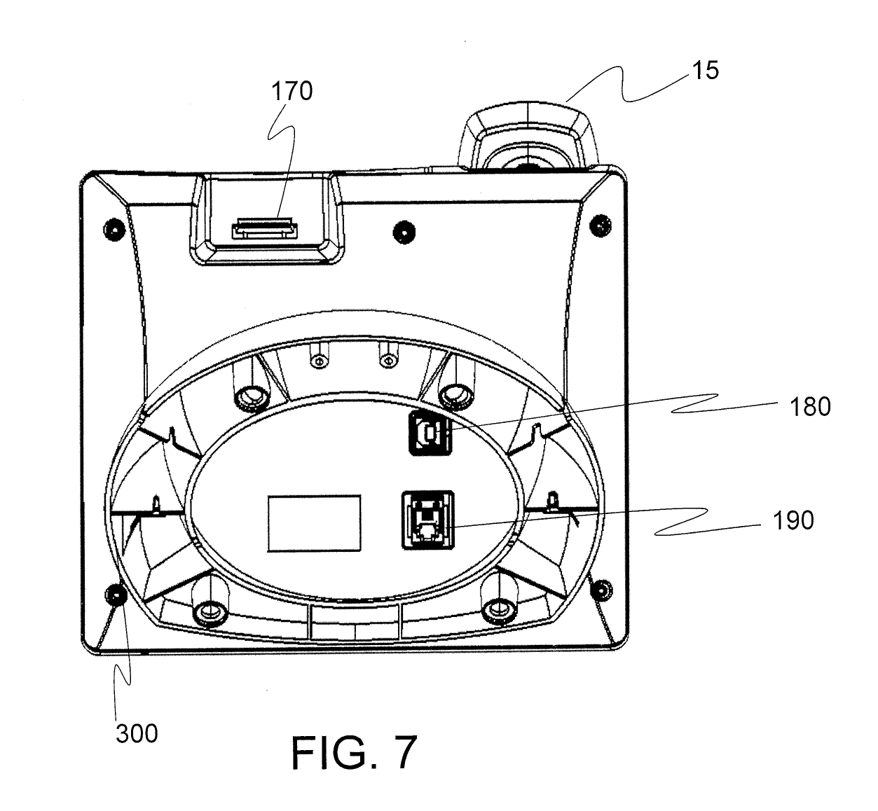

FIG. 7 illustrates yet another example embodiment of the mounting support 300 wherein the mounting support 300 includes a swivel to enable the docking station 10 to swivel in a circular manner It is appreciated that other types of supports for the docking station can be used, including those suitable for supporting the docking station on horizontal surfaces, vertical surfaces, and other context-specific surfaces (e.g. in a car, or airplane or boat).

Docking station 10 further includes a support adapter 310 on the rear face of the docking station 10 adapted to fit the mounting support 300.

The dial pad 17 enables a user to enter a telephone number to initiate a telephone call when the mobile device 50 is docked. Individual keys including the dial pad may be assigned to various numbers and letters. The dial pad 17 may further be configured to apply various functions of the mobile device, such as dialing a number, entering text while composing a text message or an e-mail, and navigating through menus and selections displayed on the mobile device 50, for example. The dial pad 17 may be able to fully interface with the mobile device 50 to enable the user to perform complex tasks such as, for example, navigate and select the desired recipient from a list of contacts stored on the mobile device 50, and access the pre-programmed speed-dial function of the mobile device 50, such that the user does not have to dial the full phone number of the desired recipient in order to place a call.

Although the docking station 10 shown in the figures can be used in a home or office environment, it should be noted that the docking station 10 can alternatively be provided in a vehicle, a kitchen appliance, or any other environment where the docking station may be used.

Referring now to FIG. 4, an example embodiment of a docking station 10 is shown without a docking module 11. The docking station 10 includes an interface 151 that is configured to receive a docking module 11. The interface 151 may include one or more recesses 150, 170 adapted to securely mount the docking module. In a preferred example embodiment, the docking station 10 is configured to receive different types of docking modules 11. In other words, the docking module 11 is attachable to and removable from the docking station 10.

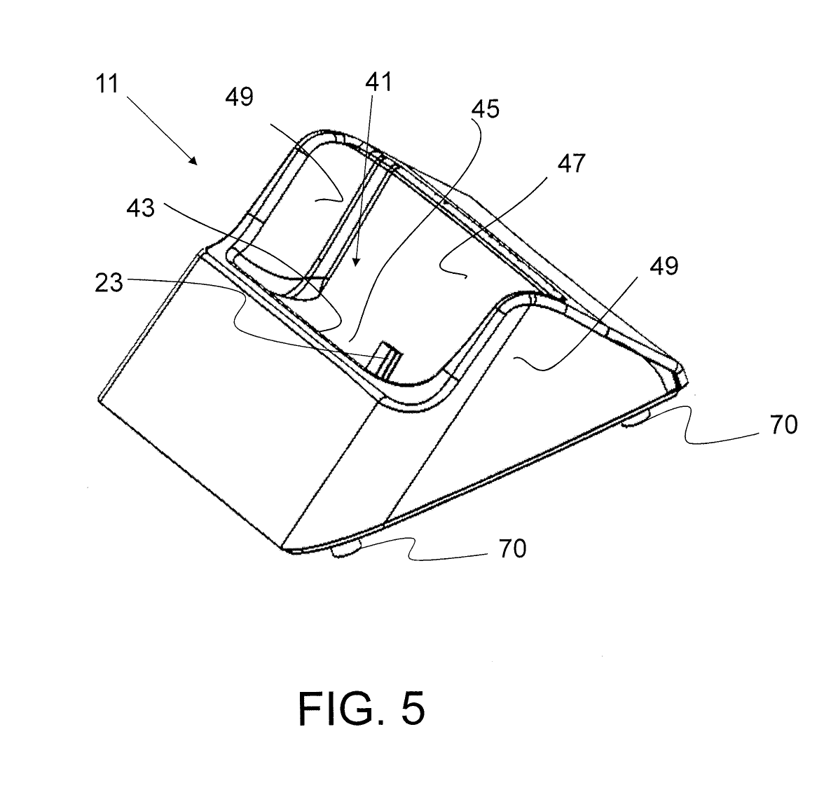

FIG. 5 illustrates an example embodiment of a docking module 11. The docking module 11 includes a space 41 to receive a mobile device 50. The space is defined by at least a front barrier 43 to retain the mobile device and a lower surface 45 to support the mobile device. The space may also be defined by a back surface 47 and side barriers 49. Docking module 11 includes one or more mounting elements 70, operable to enable mounting of the docking module 11 on to the interface 151 of the docking station 10. Examples of retaining mounting elements include cantilever type snap fits, annular snap sits, screws, magnetic attraction, VELCRO®, drop-in or slide-in slots, friction-fit, and other mechanical or electromagnetic joining mechanisms, or any combinations thereof.

The mounting elements are adapted to be retained by corresponding retaining elements of the docking station 10. For example, the mounting elements 70 that are shown in FIG. 5 may be retained by the corresponding recesses 150 provided on the docking station 10 as shown in FIG. 4.

FIG. 4 further illustrates an aperture 170 with which a cantilever type snap fit can releasably engage.

The mounting elements 70 are preferably removably engageable with the retaining elements, providing an interchangeable docking module.

One or more of the mounting elements 70 may further comprise or have disposed thereon a current transmission element (not shown). The current transmission element enables the docking station 10 to deliver an electric current to the docking module 11, which may be provided to the mobile device 50 when docked. It will be appreciated that the current transmission element could alternatively be a contactless current transmission element, in which case it could be disposed within or on the surface of the docking module 11.

In a general example embodiment, the docking module is configured to receive a mobile device and is configured to be removably mounted to a docking station. The docking module includes a space configured to receive the mobile device. The space is defined at least by a front barrier configured to retain the mobile device and a lower surface configured to support the mobile device. The docking module also includes at least one mounting element configured to interface with the docking station, a current transmission element configured to receive current from the docking station, and at least one charging module configured to transmit current received from the docking station to the mobile device.

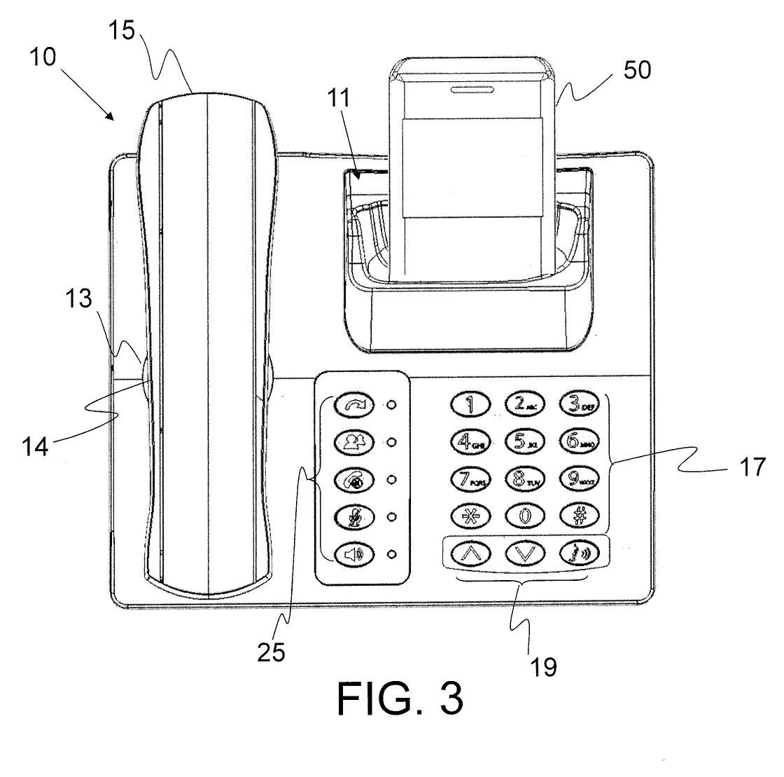

As the docking module 11 may be interchangeable, docking module 11 may be operable to enable specific models of mobile device 50 to be docked in one or more orientations, or varieties of different models of mobile device 50 in one or more orientations. For example, the mobile device 50 may be docked in an upright position as illustrated in FIG. 1. Alternatively, the mobile device 50 may be docked sideways or at an angle as in FIG. 3.

Preferably, a plurality of docking modules 11 are provided, each docking module adapted to receive one or more various models of mobile device 50. Thus, the docking station 10 can be used with many varieties of mobile devices 50, since various users choose or are required to use various models of mobile devices 50.

Furthermore, as the docking module 11 is removably mountable to the docking station 10, various docking modules 11 may be interchanged as users change their mobile devices 50 or other users with other models of mobile devices 50 wish to use the docking station 10. In other words, different docking modules can be used for different mobile devices. This allows a user to select a docking module suited for the user's own mobile device, and to mount the docking module to the docking station.

In an example embodiment, a kit of parts is provided, which includes the docking station 10 and the docking module 11. The user can assemble the docking module 11 with the docking station 10. It will be appreciated that the docking module may be sold separately from the docking station.

In another example embodiment, the docking station 10 and the docking module 11 are integrated so that the docking module 11 is not removable from the docking station.

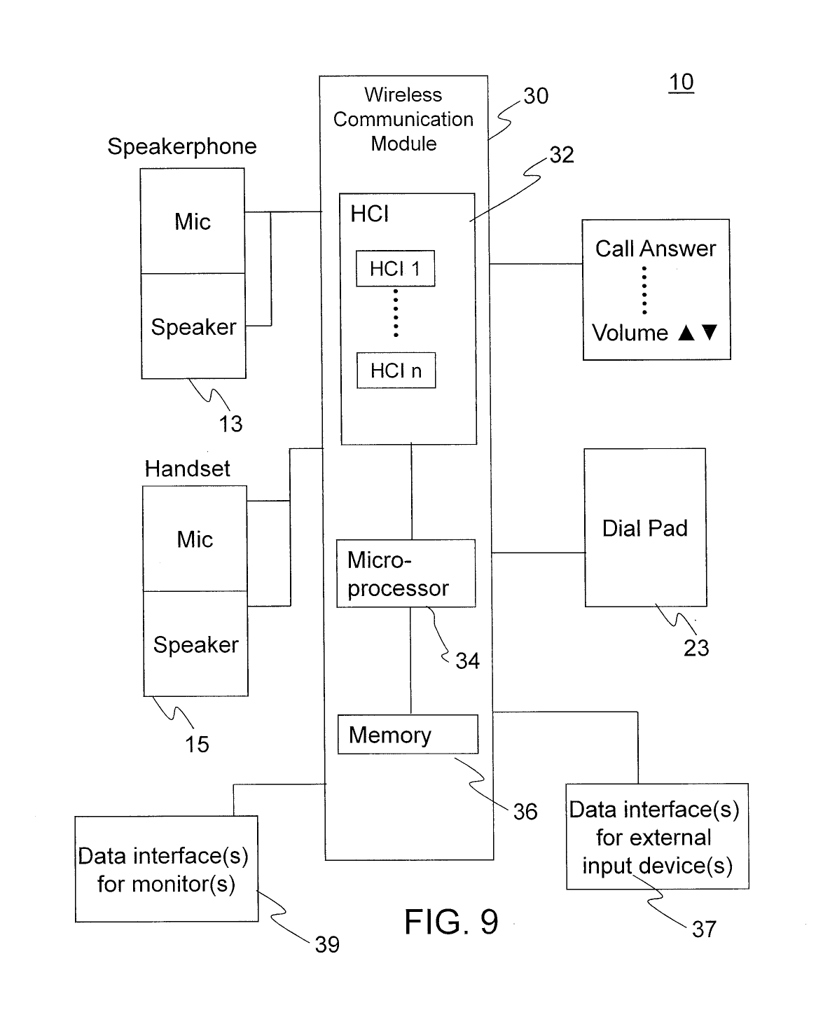

Referring now to FIG. 9, docking station 10 may comprise a short-range wireless communication module 30. Short-range wireless communication module 30 is operable to transmit and receive data wirelessly between the docking station 10 and the mobile device 50. Short-range wireless communication module 30 may, for example, implement the Bluetooth protocol. In the case of a typical short-range wireless communication module such as Bluetooth module, the data is transmitted and received through a host controller interface (HCI) 32. In an example embodiment, there may be multiple HCIs (e.g. HCI 1, . . . , HCI n) to accommodate multiple mobile devices docked on the docking station 10. In general, it can be appreciated that the HCI 32 can accommodate at least one mobile device.

The wireless communication module 30 further includes a microprocessor 34, a memory 36, and an antenna (not shown). While the microprocessor 34 primarily processes electronic signals for communication purposes, it also enables processing of other information. In a preferred embodiment, microprocessor 34 processes all electronic signals received from and transmitted to all input/output modules of the docking station 10, thus eliminating the need for additional microprocessors. Once a connection is established between the docking station 10 and the mobile device 50, at least a portion of incoming data received by the mobile device 50 through the telecommunication channel is transmitted to the HCI 32 over a short-range wireless communication link. Similarly, all data received by the input modules on the docking station 10 is transmitted to the mobile device 50 through the short-range wireless communication link, and processed data is subsequently sent to the recipient through the telecommunication channel Audio data from the mobile device 50 is transferred to the docking station 50 and can be outputted through the speakerphone's speaker 13 or the handset's speaker 15. Audio data received from the speakerphone's mic or the handset's mic is transferred from the docking station 10 to the mobile device using the wireless communication module 30. While the wireless communication module 30 is primarily used for transmitting telecommunication data, it can be used to transmit other forms of data such as audio files of saved voice messages or music files, for example, to be transmitted through the audio speaker 13.

Additionally, a connection status indicator (not shown) is in communication with the microprocessor 34. The connection status indicator may toggle or flash, for example, when the connection is established. The flashing indicator is used to indicate that the connection between the mobile device and the docking station is being established. The connection status indicator stops flashing and remains in an on-state when the connection has been made. In another example embodiment, the connection status indicator may be on when there is no connection and turn off when there is a connection, or vice versa. Alternatively, the connection status indicator may flash for the duration that the connection is present. Alternatively, the connection status indicator may flash for a predetermined period when the connection is first established. Additionally, the connection status indicator may toggle or flash, for example, when the connection is disconnected.

Continuing with FIG. 9, function keys on the docking station 10 are also connected to the wireless communication module to send commands to the mobile device 50. Input controls 33 that can be activated by the function keys include those for controlling the call answer function and the volume function. It can be appreciated, however, that in an example embodiment the audio data provided by the mobile device 50 and sent to the docking station 10 is processed and can be amplified. In other words, the control and the processing of the volume are provided by the docking station 10.

The docking station 10 may further include one or more data interfaces 37 for external input devices. For example, to interface with display devices, such as monitors. The data interface or interfaces may be a high-definition multimedia interface (HDMI), a video graphics array (VGA) interface, a digital visual interface (DVI), or a combination thereof. This allows data from the mobile device 10 to be transmitted through the docking station 10 and then to a monitor or display device for visual display of the data (e.g. pictures, movies, graphics, GUIs, etc.). In a non-limiting example embodiment, two monitors can be connected to the docking station.

The docking station 10 may further include one or more data interfaces 39 to interface with input devices, such as keyboard and a mouse. The data interface 39 may be wired or wireless. For example, wireless input devices can be used to input data into the docking station 10, and the inputted data is transmitted from the docking station 10 to the mobile device 50 through the wireless communication module 30.

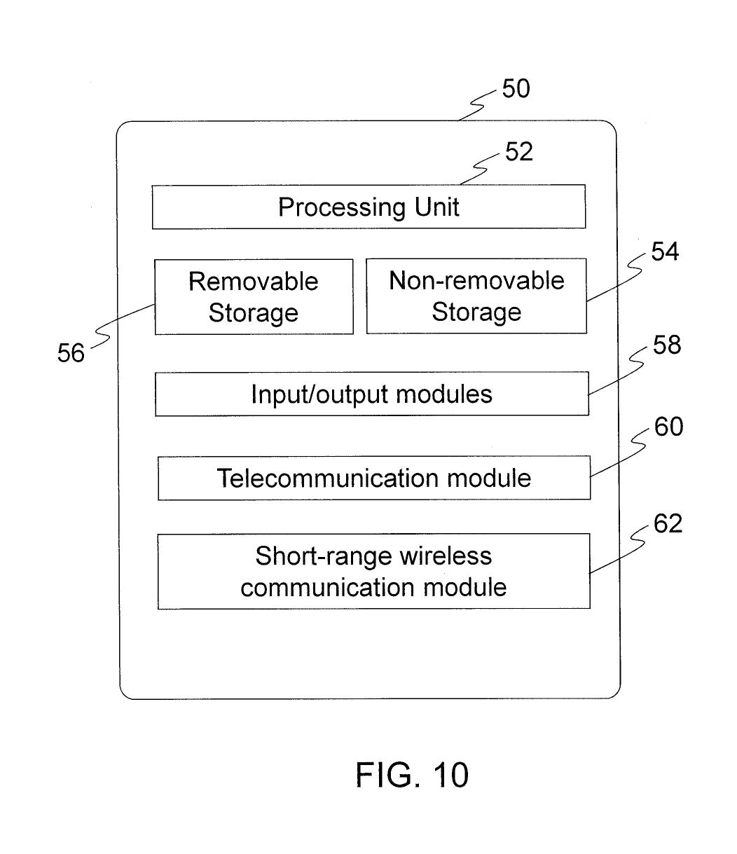

FIG. 10 shows an example of a typical mobile device. A typical mobile device may include a processing unit 52, removable memory 54, non-removable memory 56, telecommunication module 60, and a short-range wireless communication module 62. It will be appreciated that the short-range wireless communication module 30 of the docking station 10 implements at least one protocol compatible with the short-range wireless communication module 62 of the mobile device. In this regard, it will be appreciated that a pairing routine may be required to be executed as between the mobile device 50 and the docking station 10.

A typical mobile device 50 may further comprise a display; an input device such as touchscreen, a dial pad, keyboard; a speaker; a microphone; and a camera. The camera may be used for video conferencing such as by transmitting a real-time video feed to a recipient or a group of recipients during a voice communication.

The mobile device may further comprise an audio signal processing unit for enabling voice recognition. For example, the audio signal processing unit may be operable to convert a user's vocal command received by the microphone 14 or handset 15 to operations of the mobile device. Such operations may, for example, include dialing a desired telephone number, or initiating video conferencing, etc.

The mobile device can be docked to the docking station using a number of different methods described previously. For example, the mobile device 50 may be placed by a user upon the docking module 11 so as to initiate charging of the mobile device 50, for example by placing the mobile device 50 on the docking module 10 in such a way that a charging port 23 engages with a charging inlet.

Once the mobile device 50 is docked to the docking station 10, the docking station 10 may automatically attempt to establish a communication link with the mobile device 50 using its short-range wireless communication module 30 (subsequent to the execution of a pairing routine, in some examples). In one embodiment, the docking station 10 may prompt the user to acknowledge that a connection is being made before an attempt to establish a communication link is made. In another embodiment, the user may be able to manually establish a communication link by using the mobile device 50 to first locate the docking station 10 within its available networks, and then choose to connect to the docking station 10 without physically placing the device in the charging port 23.

In one aspect, a communication link between the docking station 10 and the mobile device 50 is only established when the mobile device 50 is docked to the docking station 10 in order to eliminate any accidental communication links.

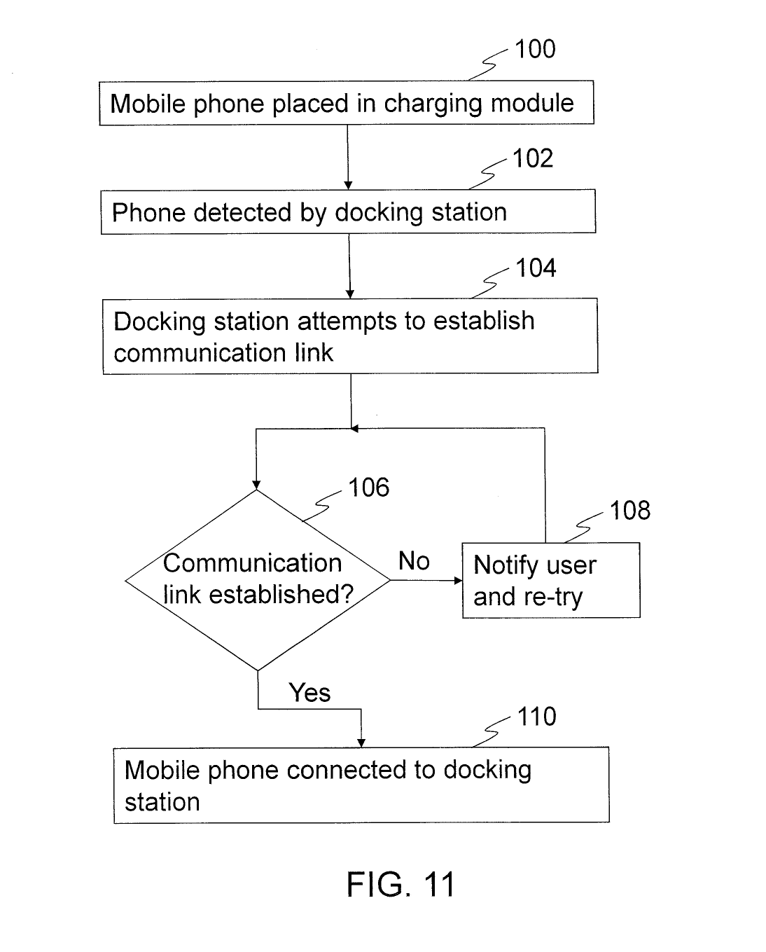

Referring now to FIG. 11, the docking system 10 is described in an example operation. The mobile device 50 is placed upon the docking module 11. The docking module delivers a charge to the mobile device via the charging port so as to charge a battery of the mobile device. Correspondingly, the docking station detects the docking of the mobile device 102. The docking station automatically attempts to establish a wireless communication link with the mobile device 104, and the docking station determines whether the communication link was successfully established. If the docking station determines that the communication link could not be established 106, the user may be notified of the failure to establish the communication link, and the docking station may attempt to establish the communication link again 108. In another embodiment, the user may be able to specify the maximum number of attempts the docking station can make to establish the communication link with the mobile device. Once the docking station is able to confirm that the communication link has been established with the mobile device 110, the user may be notified by a brief visual or audio cue. In an example embodiment, the connection status indicator is used to indicate the communication link has been established.

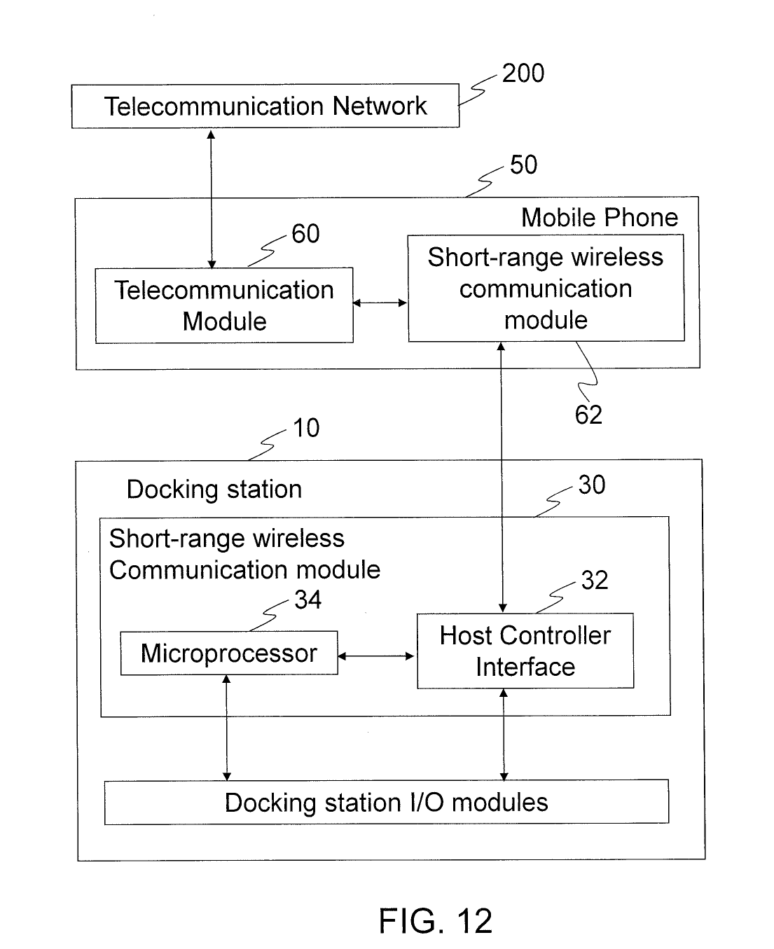

Referring now to FIG. 12, the connection between the docking station 10 and the mobile device 50 is now described. The mobile device maintains communication with the telecommunication network 200 through its telecommunication module 60. Telecommunication module 60 is operable to receive and transmit all telecommunication data for the mobile device 50, including phone calls, text messages, e-mails, and other communication channels established by applications installed on the mobile device 50. Once the mobile device 50 is docked and the communication link between the mobile device 50 and the docking station 10 is established through the wireless communication modules, at least a portion of the telecommunication data is exchanged between the telecommunication module 60 and the short-range wireless communication module 62. This data is then transmitted to the HCI 32 of the short-range wireless communication module 30, and to the appropriate input/output modules of the docking station. Similarly, any data received by the input/output modules of the docking station can be transmitted to the mobile device 50 through the host controller interface 32 of the short-range wireless communication module 30 of the docking station. Certain data received from the I/O modules can be first processed by the microprocessor 34 before being transmitted by the host controller interface 32.

In practice, telephone calls initiated from or received by the mobile device can be conducted using the docking station's microphone and speaker.

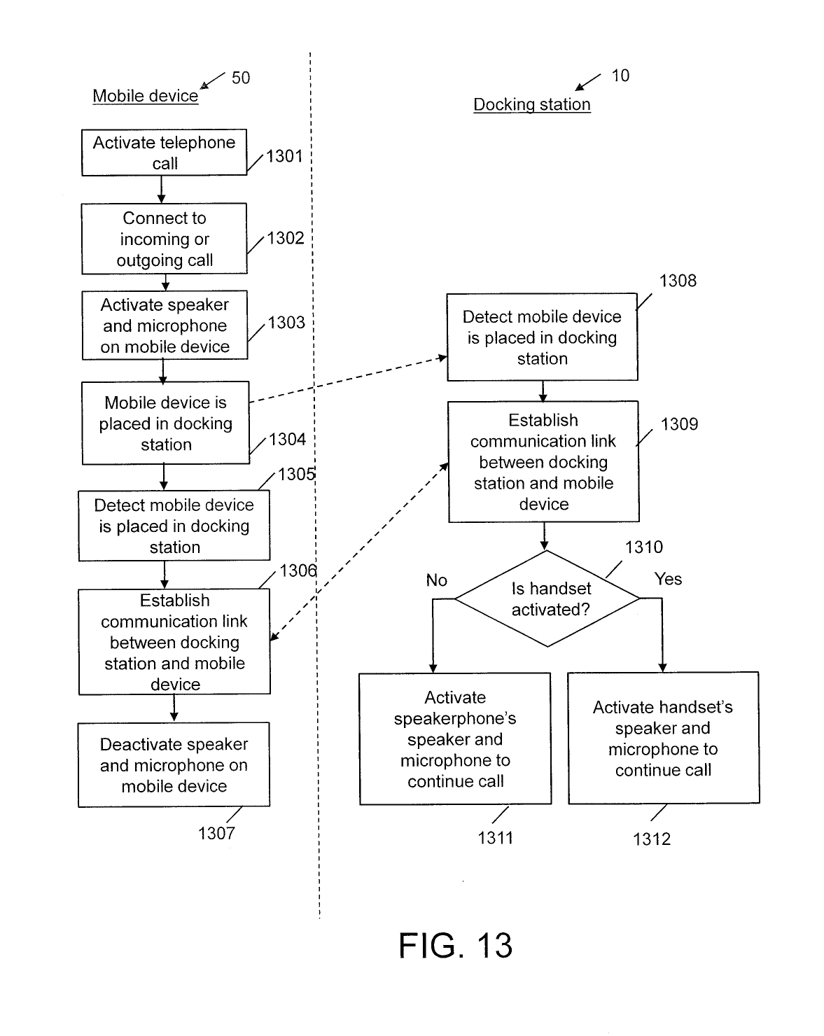

Referring to FIG. 13, an example operation of using the docking station 10 while midway in a telephone call using the mobile device 50. The mobile device is activated for a telephone call 1301 and is connected to an incoming call or an outgoing call 1302. It is appreciated that the mobile device 50 at this stage has not yet been docked in the docking station 10. For example, the user may be holding the mobile device in their hand, as an example typical use of the mobile device. After connecting to the incoming call, the speaker and microphone on the mobile device are activated. In this way, the user can carry out a telephone conversation using the mobile device, as typically used. While the mobile device maintains the telephone connection to the call, the mobile device is placed in the docking station 1304. As a result, the mobile device detects that it is placed in the docking station 1305, and similarly, the docking station detects that the mobile device is placed in the docking station 1308. Each of the mobile device and the docking station establish a communication link between each other 1306, 1309. The mobile device deactivates the speaker and microphone on the mobile device 1307.

When the docking station has established a communication link with the mobile device, the docking station determines if the handset is activated or not 1310. If the handset is not activated, then the hands-free speakerphone is automatically activated. In other words, the speaker and microphone of the speakerphone are automatically activated to continue the telephone call 1311. If the handset is activated, then the handset's speaker and microphone are activated to continue the telephone call 1312. Therefore, a user can simply and conveniently be in the middle of a telephone conversation using their mobile device in a typical manner (e.g. holding the mobile device), place their mobile device in the docking station, and then seamlessly continue the telephone conversation using a speaker and a microphone on the docking station. The user does not need to press any buttons as the process is automatic.

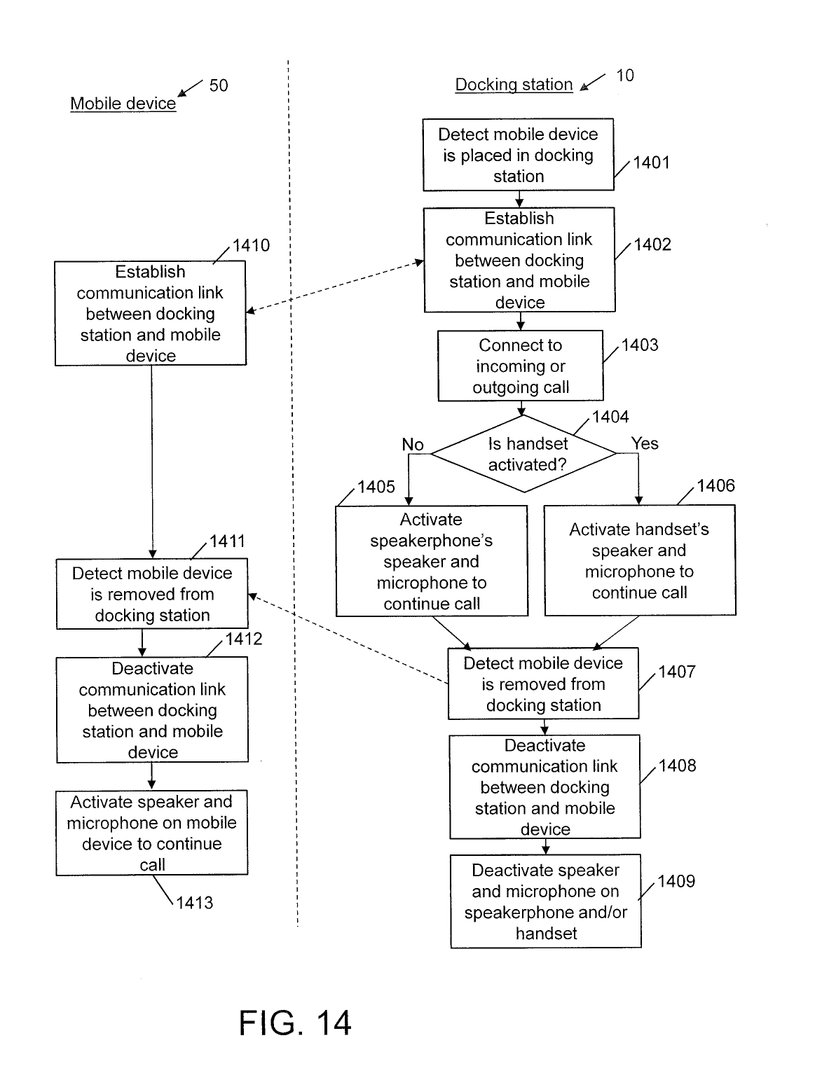

Referring to FIG. 14, an example operation of using the docking station 10 and mobile device 50 is provided. In this example, the mobile device is initially docked in the docking station. In particular, the docking station detects the mobile device is placed in the docking station 1401 and this triggers a communication link to be established between the docking station and the mobile device 1402, 1410. The docking station is then used to connect to an incoming call or to an outgoing call 1403. The docking station determines if the handset is activated 1404. If the handset is not activated, then the speakerphone's speaker and microphone are activated to continue the telephone call 1405. If the handset is activated, the handset's speakerphone and microphone are activated to continue the call. In this way, the user uses the docking station 10 to carry out a telephone conversation. While the telephone call is still being maintained, the docking station detects that the mobile device is removed from the docking station 1407. For example, the user may remove the mobile device 50 from the docking station 10 midway during a telephone conversation. The docking station then deactivates the communication link between the docking station and the mobile device 1408 and deactivates the speaker and the microphone on the docking station (e.g. on the speakerphone or handset, or both) 1409.

When the mobile device detects the mobile device is removed from the docking station 1411, the mobile device deactivates the communication link between the docking station and the mobile device 1412. The mobile device also activates the speaker and the microphone on the mobile device to continue the call. Therefore, while a user is in a telephone conversation using the docking station, the user can simply remove their mobile device from the docking station. The telephone conversation is then seamlessly continued using the speaker and the microphone on the mobile device, so that the user can use the mobile device in a typical manner (e.g. holding the mobile device to talk). The user does not need to press any buttons as the process is automatic.

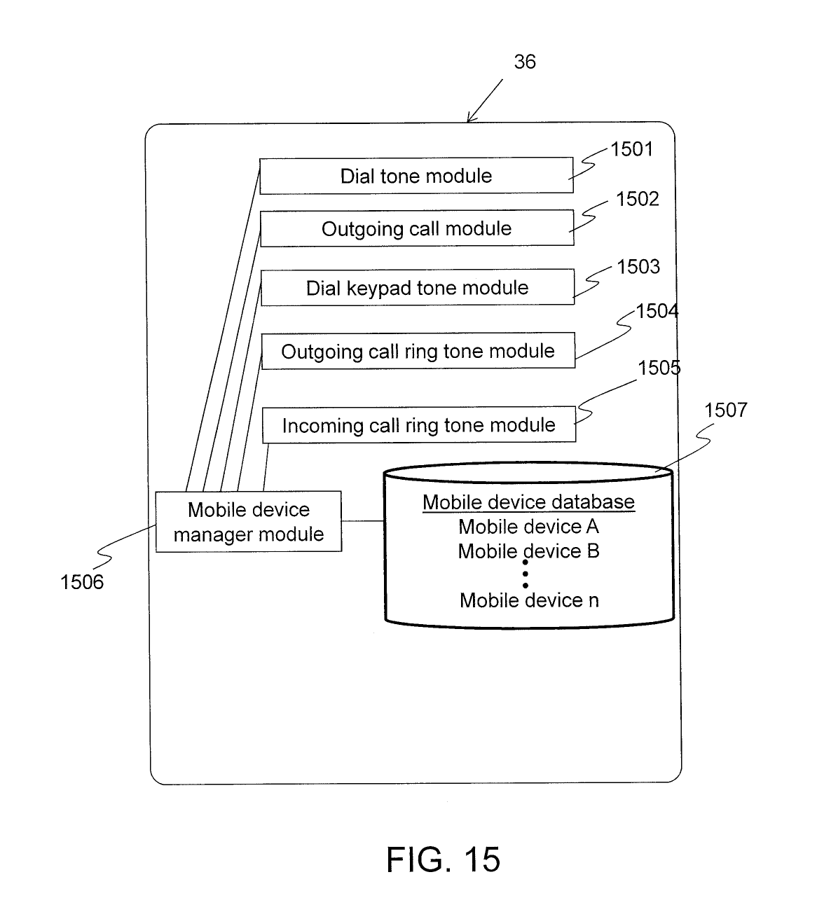

Turning to FIG. 15, example modules and components of the docking station's memory 36 are illustrated. The memory 36 includes a mobile device manager module 1506, a mobile device database 1507, a dial tone module 1501, an outgoing call module 1502, a dial keypad tone module 1503, an outgoing call ring tone module 1504, and an incoming call ring tone module 1505.

The mobile device manager module 1506 includes, for example, the processor executable instructions described herein. The module 1506 also initiates other functions that are provided by modules 1501, 1502, 1503, 1504, and 1505. The mobile device manager module 1506 is also configured to coordinate settings (e.g. ring tone settings, communication settings, etc.) for different mobile devices.

The mobile device database 1507 includes identifications of different mobile devices that have been docked, or will be docked in the docking station. Preference settings are associated with each of the mobile device identifications. For example, the identification is a name, a telephone number of the mobile device, a SIM card identification of the mobile device, or an alphanumeric value. The preference settings may include ring tones to help a user distinguish an incoming call associated with one mobile device compared to another mobile device. As will be discussed later, different mobile devices can be docked or placed into the docking module of a docking station either one at a time, or at the same time. In another example embodiment, if memory 36 is of a first docking station, there may be a second docking station in communication with the first docking station. The second docking station may have docked thereon a mobile device, and it's mobile device identification may be stored in the mobile device database 1507 of the first docking station. Further details in this regard are provided below.

Continuing with FIG. 15, the dial tone module 1501 includes data and executable instructions for generating a dial tone sound. For example, in a typical landline telephone, when a user activates the telephone to make a call (e.g. by lifting a receiver off the hook or hitting the “dial” button”) a dial tone is heard from the telephone's speaker to indicate a telephone exchange is working and is ready to accept a call. This type of dial tone can be synthetically generated or played, for example, using an audio file stored in the dial tone module 1501.

The outgoing call module 1502 includes data and executable instructions for storing digits for an outgoing call. The dial keypad tone module 1503 includes data and executable instructions for generating or playing audio data when a button is pressed (e.g. including buttons 17. 19 and 25). The outgoing call ring tone module 1504 includes data and executable instructions for generating and playing a ring tone when an outgoing call is being made. The incoming call ring tone module 1505 includes data and executable instructions for generating and playing a ring tone when an incoming call is being made. Modules 1503, 1504 and 1505 generate or play sounds which are used in replacement of the sounds generated by the mobile device, when the mobile device is docked in the docking station.

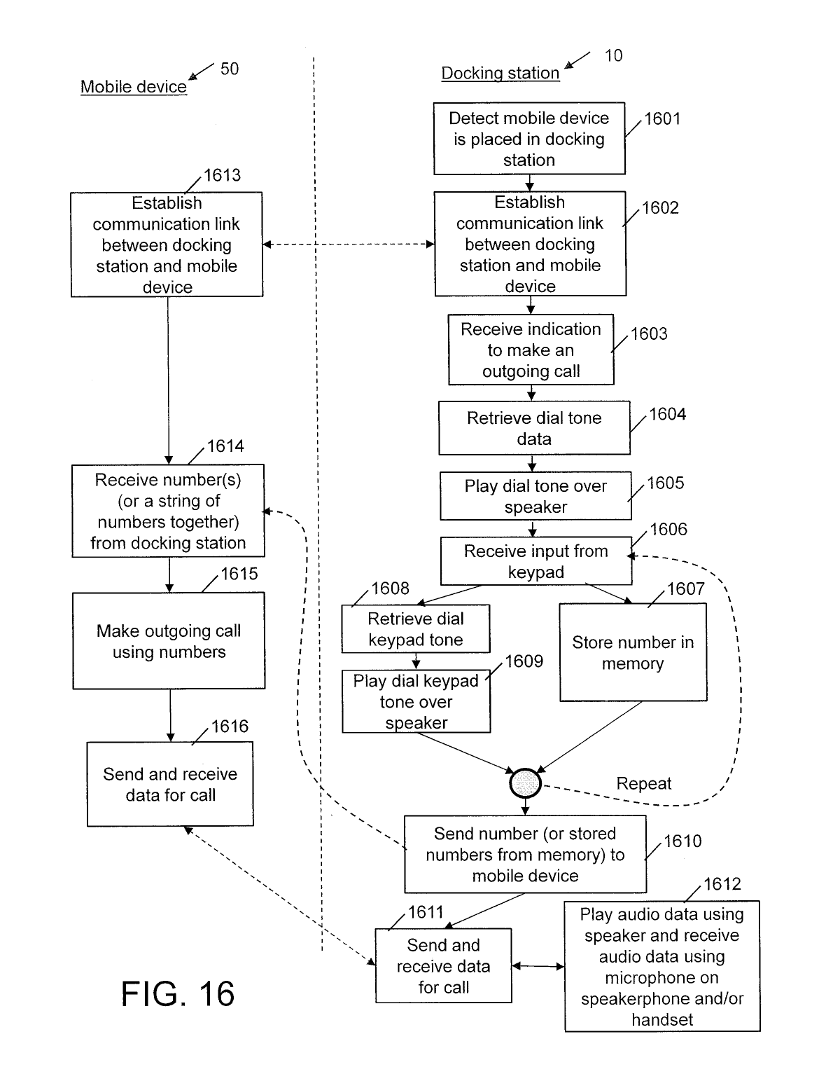

Referring to FIG. 16, an example operation of making a telephone call is provided when the mobile device 50 is docked in the docking station 10. When the mobile device is placed in the docking station, the docking station detects the mobile device is placed in the docking station 1601. A communication link is established between the docking station and the mobile device 1602, 1613. The docking station receives and indication to make an outgoing call 1603. For example, a user may hit a button on the docking station that indicates the user intends to make a call, or the user may lift the handset 15 off the docking station 10 to provide the indication. After receiving this indication, the docking station retrieves the dial tone data 1604, for example from the dial tone module 1501, and plays the dial tone over a speaker of the docking station 1605. At this stage, the user enters in numbers using a dial pad. The docking station receives an input from the keypad 1606, for example, when a user presses number. The docking station stores the number associated with the input into memory 1607 (e.g. in module 1502). In the alternative to block 1607, or in combination, the docking station retrieves a dial keypad tone 1608 (e.g. from module 1503), and plays the dial keypad tone over the speaker 1609. The process of 1606, 1607, 1608, and 1609 repeat for each input from the keypad. Based on blocks 1608 and 1609, the user is provided with audio feedback that a button has been pressed. Based on block 1607, the digits of a complete telephone number are stored in memory on the docking station.

The docking station then sends the number or numbers to the mobile device 1610. If the numbers of a telephone number are stored in memory, the complete string of telephone numbers is sent to from the docking station to the mobile device 50. Otherwise, the docking station sends each inputted number, one at a time, to the mobile device when each inputted number is received by the docking station. In a preferred example embodiment, the numbers are automatically sent from the docking station 10 to the mobile device 50 and no further user input is required. For example, hitting a “send” or “dial” button after dialing the numbers is not required. This provides the user with a more familiar telephone experience. In another example embodiment, a further user input initiates the sending of the numbers to the mobile device.

The mobile device receives the number or numbers from the docking station 1614. The mobile device makes an outgoing call through the telecommunication network using the numbers 1615. When the call connection is established, the mobile device and the docking station both sends and receive data for the call between each other 1616, 1611. In particular, audio data received from the mobile device is sent to the docking station, and the docking station plays the received audio data using a speaker 1612. Conversely, audio data received by a microphone of the docking station is sent to the mobile device, and the mobile device transmits the audio data from the docking station through the telecommunication network.

It is appreciated that playing the dial tone and the dial keypad tones on the docking station 10 provide a familiar telephone experience to the user.

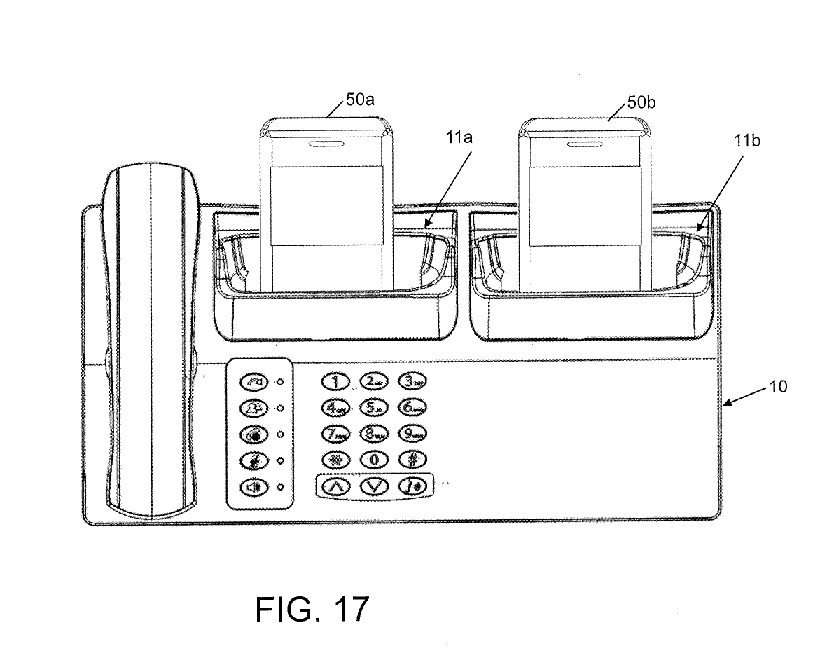

Referring to FIG. 17, another example embodiment of a docking station 10 is provided, and is particularly configured to accommodate docking two mobile devices 50a, 50b. The functionality of the docking station 10 in this embodiment is similar to the previously described embodiments of the docking station. The docking station 10 shown in FIG. 17 includes two docking modules 11a, 11b, each configured to receive a mobile device. It can be appreciated that docking module 11a may be different from docking module 11b, so that different mobile devices can be docked at the same time. The mobile device identifications of the two mobile devices can be stored in the database 1507 along with their associated ring tones. Therefore, when an incoming call is detected for a first mobile device 50a, the ring tone from the docking station 10 will be a first ring tone. When an incoming call is detected for a second mobile device 50b, the ring tone from the docking station 10 will be a second ring tone, which is preferably different from the first ring tone. This helps a user distinguish between which mobile device is receiving the incoming call.

Although two mobile devices are shown being docked in the docking station 10 in FIG. 17, it is appreciated that other embodiments of a docking station are configured to accommodate a higher number of mobile devices being simultaneously docked.

Although not shown in FIG. 17, in an example embodiment, the two docking modules are removably mountable to two separate interfaces (like interface 151) located on the user facing surface of the docking station 10. In other embodiments, the docking station includes more than two interfaces.

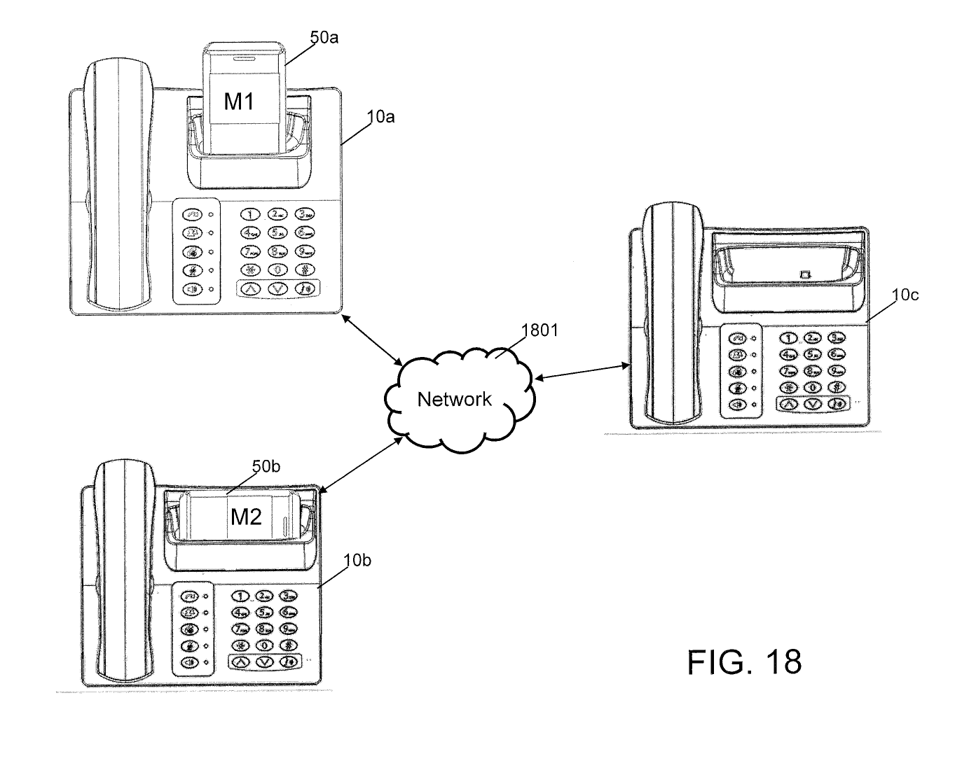

Referring to FIG. 18, an example embodiment of a system of several docking stations 10a, 10b, 10c are shown in communication with each other over a network 1801. The docking stations may be in wired or wireless communication with each other. In another example embodiment, the docking stations are each in communication with each other, without use of a network 1801. The docking stations, for example, may be in communication with each other using a LAN network, WAN network, WiFi, Bluetooth, or radio.

In this example, a first mobile device 50a is docked on a first docking station 10a. A second mobile device 50b is docked on a second docking station 10b. The third docking station does not have any mobile device docked thereon.

From any one of the docking stations, an outgoing call can be made using any mobile device that is docked, even if the mobile device is docked on a different docking station compared to the docking station used to make the outgoing call. Conversely, any one of the docking stations can be used to receive an incoming call from any mobile device that is docked, even if the mobile device is docked on a different docking station compared to the docking station used to receive the incoming call.

For example, in a household environment, there may be a docking station placed in different areas of a home (e.g. upstairs, downstairs, kitchen, etc.). Using multiple docking stations allows a user to answer an incoming call or make an outgoing call from any given docking station, without needing to worry about which docking station the mobile device is docked within For example, if a user is physically closer to the third docking station 10c, and an incoming call from the first mobile device 50a is being received, the user can use the third docking station to answer the incoming call. In another example, a user is physically closer to the second docking station 11b, but desires to make an outgoing call using the telephone number associated with the first mobile device 50a. The user can make the desired call from the second docking station 10b, because the first and the second docking stations 10a, 10b are in communication with each other.

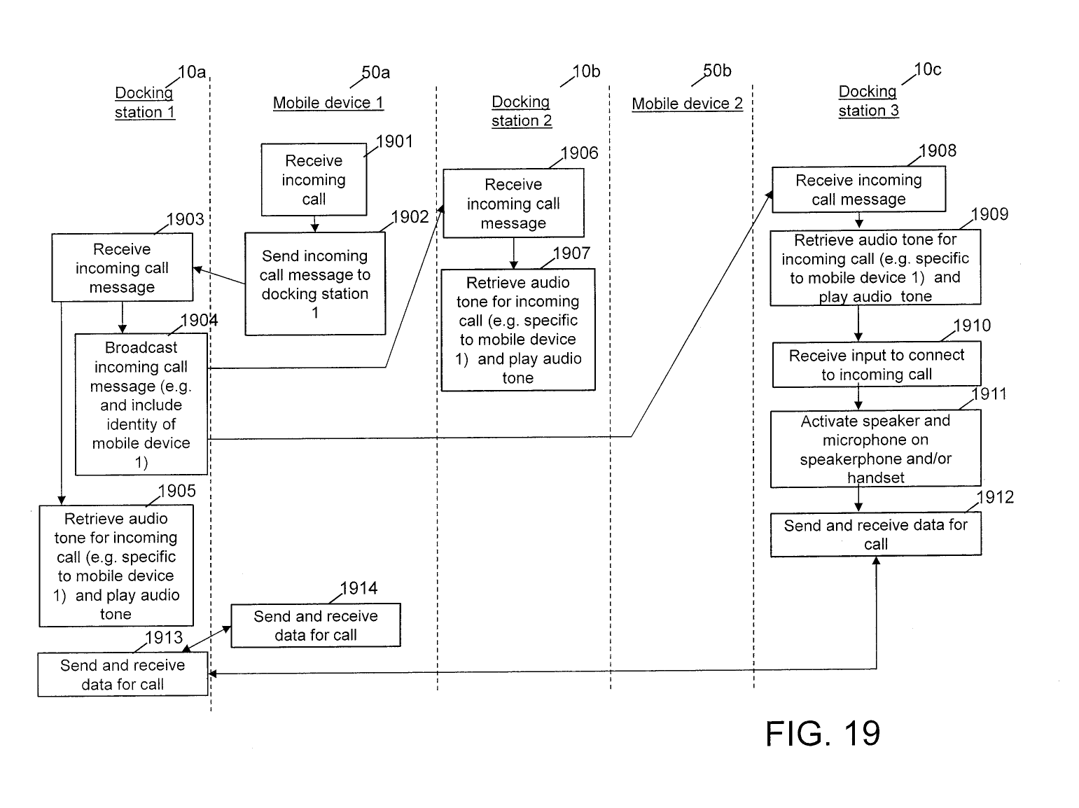

Referring to FIG. 19, an example operation of receiving an incoming telephone call is provided when the mobile device receiving the call is docked in a first docking station, and the call is received using another, or second docking station.

The first mobile device 50a is docked on a first docking station 10a, and one or more other docking stations 10b, 10c are in communication with the first docking station. The first mobile device receives an incoming call over a telecommunication network 1901. The first mobile device sends an incoming call message to the first docking station 1902. The first docking station receives the incoming call message from the first mobile device 1903 and sends or broadcasts the incoming call message to the other docking stations 1904. The broadcasted message may include an identification of the first mobile device. The first docking station retrieves an incoming call ring tone (e.g. from module 1505) and plays the same ring tone using the speaker on the first docking station 1905. In an example embodiment, the incoming call ring tone is specific or unique to the first mobile device.

A second docking station 10b receives the incoming call message from the first docking station 1906. The second docking station similarly retrieves an incoming call ring tone (e.g. from module 1505) and plays the retrieved ring tone on a speaker of the second docking station 1907.

A third docking station 10c receives the incoming call message from the first docking station 1908. The third docking station similarly retrieves an incoming call ring tone (e.g. from module 1505) and plays the retrieved ring tone on a speaker of the second docking station 1909. At this stage, a user may hear the ring tones from each of the docking stations and may choose to answer the incoming call using any of the docking stations.

In the example of FIG. 19, the user chooses to use the third docking station, although the first or the second docking station could also have been chosen. The third docking station receives an input to connect to the incoming call 1910. For example, the user lifts the handset of the third docking station or presses a button on the third docking station to answer the call. The third docking station then activates the speaker and microphone on the speakerphone or the handset, or both 1911. Data (e.g. audio data, video data, text data, etc.) is then exchanged between the third docking station and the first docking station 1912, 1913. Data is also exchanged between the first docking station and the first mobile device docked thereon 1913, 1914. For example, audio data from the user inputted into the third docking station is sent to the first docking station, and from the first docking station the audio data is sent to the first mobile device for transmission over the telecommunication network. Incoming audio data received by the mobile device over the telecommunication network is transmitted to the first docking station, and then is sent from the first docking station to the third docking station to be played on a speaker.

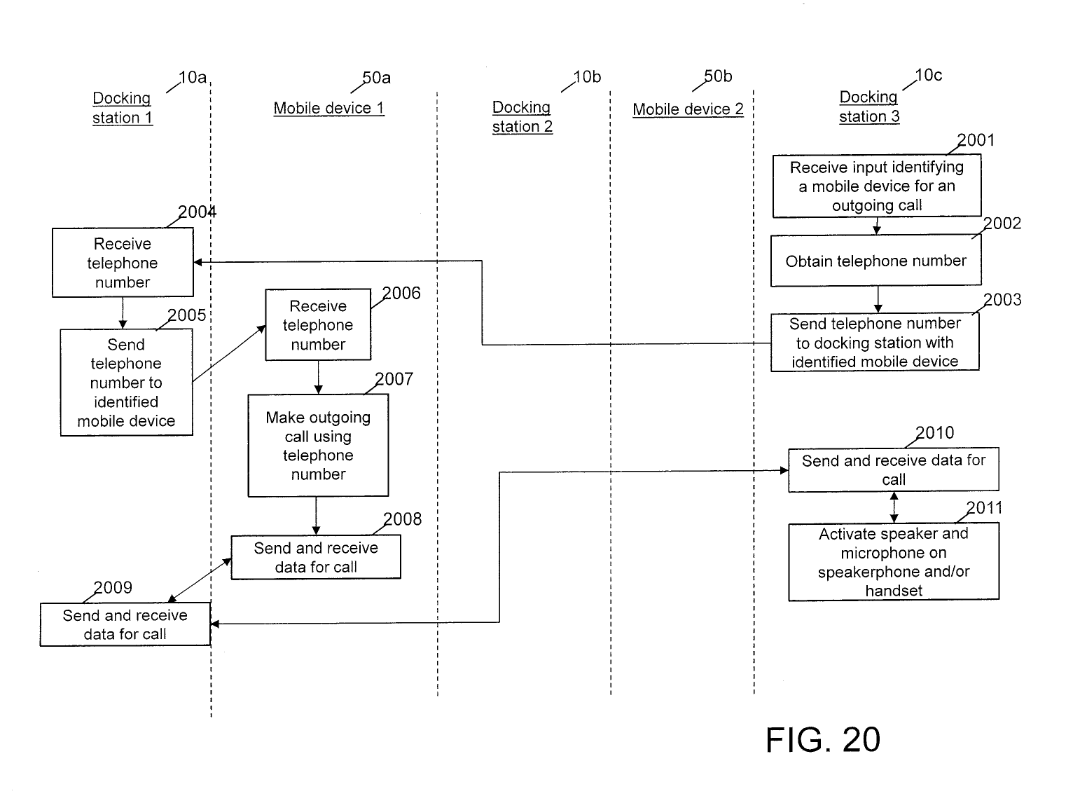

Referring to FIG. 20, an example operation of making an outgoing telephone call is provided when the mobile device used to make the call is docked in a first docking station, and the call is placed using another, or second docking station.

In this example, a first mobile device 50a is docked in a first docking station 10a. The outgoing call is being made using a third docking station 10c.

The third docking station receives an input identifying a mobile device for an outgoing call 2001. This step is optional. If, for example, it is detected that there is only one mobile device docked amongst the connected docking stations 10a, 10b, 10c, then any outgoing calls will automatically be made using the one mobile device. In another example, when there are multiple mobile devices docked, not necessarily in the same docking station, a mobile device may be selected as a default so that all outgoing calls are automatically made using the default mobile device. In yet another example embodiment, where there are multiple mobile devices, a user may have the option to select from which mobile device the outgoing call should be made, as per block 2001.

A telephone number for the outgoing call is obtained by the third docking station 2003. For example, a user can select a telephone number stored in memory or may dial in a number using the dial keypad of the third docking station. The telephone number is sent to the docking station having the identified mobile device (e.g. identified either by user selection or according to a default setting). In this example, the first mobile device has been identified, so the telephone number is sent to the first docking station.

It will be appreciated that there are different ways for the correct docking station to be reached by the third docking station. In one example, the third docking station sends the telephone number and identification of the identified mobile device to all docking stations, for example, through a broadcasted message. If a given docking station has the identified mobile device docked thereon, it will make the outgoing call and exchange the audio data with the third docking station. In another example, the third docking station sends a query to each of the docking stations to determine which docking station has the identified mobile device. A docking station having the identified mobile device will send an affirmative response to the third docking station, and the third docking station then sends the telephone number to the responding docking station. In another example, a database (e.g. database 1507) on each docking station is updated with information about which mobile devices are docked on which docking stations. In other words, the third docking station looks up such a database to identify on which docking station is the first mobile device docked, and sends the outgoing telephone number to the identified docking station.

Continuing with FIG. 20, the first docking station receives the telephone number 2004. The first docking station sends the telephone number to the identified mobile device, in this example, the first mobile device 2005. The first mobile device receives the telephone number 2006 and makes an outgoing call using the telephone number 2007. Data from the mobile device is exchanged with the first docking station 2008, 2009. Data is also exchanged between the first docking station and the third docking station 2009, 2010. For example, audio data received through a microphone on the third docking station is sent to the first docking station, and from the first docking station the audio data is sent to the first mobile device. Audio data received through the telecommunication network by the first mobile device is sent to the first docking station, and from the first docking station the audio data is sent to the third docking station to be played on a speaker.

It will be appreciated that the visual design of the docking station, including its parts (e.g. the handset, the docking module, the base, etc.) can have different shapes, arrangements and sizes. In an example embodiment, the visual design of the docking station is modified to complement a consumer décor.

It will also be appreciated that the different features of the docking station described herein can be combined in various ways, although the combinations may not have been explicitly described herein. These combinations can be used and applied to the docking station.

Although the above has been described with reference to certain specific example embodiments, various modifications thereof will be apparent to those skilled in the art without departing from the scope of the claims appended hereto.

1. A docking station for a mobile device, the docking station comprising:
(a) an interface adapted to receive a docking module that is removably mountable to the interface, the docking module adapted to receive the mobile device; and
(b) a communication module operable to enable communication between the docking station and the mobile device.

2. The docking station of claim 1 further comprising a processor, a memory device, and a speaker, wherein the processor is configured to obtain a dial tone from the memory device and output the dial tone over the speaker.

3. The docking station of claim 1, wherein said docking module is operable to deliver a charging current to the mobile device when the mobile device is placed in the docking module and the docking module is mounted to the interface.

4. The docking station of claim 3, wherein the charging current is delivered wirelessly to the mobile device.

5. The docking station of claim 4, wherein the wireless delivery is inductive charging.

6. The docking station of claim 3, wherein the communication module enables communication only upon the docking module delivering the charging current.

7. The docking station of claim 1, wherein the communication is provided by Bluetooth, IEEE 802.11, infrared or radio frequency.

8. The docking station of claim 1, wherein the interface is positioned on a user facing surface of the docking station.

9. The docking station of claim 1, further comprising a microphone and a speaker.

10. The docking station of claim 9, wherein the microphone and the speaker provide full-duplex speakerphone communications via the mobile device.

11. The docking station of claim 9, further comprising a digital signal processor to condition voice communications.

12. The docking station of claim 9, further comprising a power amplifier to increase signal output of the speaker.

13. The docking station of claim 1, further comprising a plurality of buttons to control the mobile device.

14. The docking station of claim 13, wherein one or more of the buttons control user-defined functions of the mobile device.

15. The docking station of claim 1, further comprising a processor and a memory device, the processor configured to store user inputted numbers in the memory device and to send the stored numbers to the mobile device, when the mobile device is placed in the docking module and the docking module is mounted to the interface.

16. The docking station of claim 1, wherein the docking module comprises a pivot to enable the adjustment of a viewing angle of the mobile device.

17. The docking station of claim 1, further comprising a mounting support.

18. The docking station of claim 17, wherein the mounting support comprises a curved path to enable adjustment of the viewing angle of the docking station.

19. The docking station of claim 17, wherein the mounting support comprises a swivel to enable swiveling of the docking station.

20. The docking station of claim 1 further comprising a plurality of buttons positioned below the interface, the plurality of buttons and the interface positioned on a user facing surface of the docking station.

21. The docking station of claim 1 wherein the communication module is further operable to enable transmission of data between the mobile device and another docking station when the mobile device is placed in the docking module and the docking module is mounted to the interface.

22. The docking station of claim 1 further comprising a second interface adapted to receive a second docking module that is removably mountable to the second interface, the second docking module adapted to receive a second mobile device.

23. A docking station for a mobile device, the docking station comprising:
(a) a docking module adapted to deliver a charge to the mobile device; and
(b) a communication module operable to enable communication between the docking station and the mobile device upon delivering the charge.

24. A kit of parts that, when assembled, form a docking station with a docking module, the kit of parts comprising:
the docking module adapted to receive a mobile device, the docking module removably mountable to the docking station; and
the docking station comprising: an interface adapted to receive the docking module; and a communication module operable to enable communication between the docking station and the mobile device.

25. A docking module configured to receive a mobile device and a configured to be removably mounted to a docking station, the docking module comprising:
a space configured to receive the mobile device, the space defined at least by a front barrier configured to retain the mobile device and a lower surface configured to support the mobile device;
at least one mounting element configured to interface with the docking station;
a current transmission element configured to receive current from the docking station; and
at least one charging module configured to transmit current received from the docking station to the mobile device.
